(19) United States
(12) Patent Application Publication
(10) Pub. No.: US 2025/0347981 A1
(43) Pub. Date: Nov. 13, 2025

(54) ARRANGEMENT FOR GENERATING A SPACED, ADJUSTABLE LIGHT FIELD FOR MACRO PHOTOGRAPHY, ESPECIALLY FOR OBJECT-ADAPTED LIGHTING WITH A SHARP LIGHT FIELD EDGE

(71) Applicant: Volker RUSCH, Herborn (DE)

(72) Inventors: Johannes RUSCH, Brienz (CH); Andreas FUHRMANN, Uhingen (DE)

(21) Appl. No.: 18/867,979

(22) PCT Filed: May 22, 2023
(86) PCT No.: PCT/EP2023/063617

§ 371 Date: Nov. 21, 2024

(30) Foreign Application Priority Data
May 25, 2022 (DE) 10 2022 001 895.0

(51) Int. Cl. G03B 15/07

(52) U.S. Cl. CPC G03B 15/07

(57) ABSTRACT

A proposed arrangement is described for generating a spaced, adjustable light field for macro photography, for object-adapted illumination with a sharply defined light field edge. This arrangement is equipped with a continuous light source featuring a single high-power LED, followed by an optical coupling module that efficiently couples the light into a flexible fluid light guide. At the exit window of the fluid light guide, a diaphragm tube with a high-aperture condenser lens and a shading aperture is arranged. Downstream of the diaphragm tube is an imaging stage comprising at least one lens group with an imaging magnification approximately equal to one for the sharp imaging of the shading aperture to generate a light field. The sharply imaged light field, as an image of the shading aperture, is formed at a distance of at least 80 mm from the front mechanical stop of the housing of the imaging stage.

When photographing small objects and object details, which are often sensitive to air flow, sophisticated modern photography in the macro range generally requires a very sharply defined light field for object illumination. A very high illuminance in the high five-digit lux range and, if necessary, up to the six-digit lux range should be achieved on the object with continuous lighting, as well as a defined color temperature of 5600 K+/−100 K. For photography in the macro range, LEDs in the high-performance range should be used as light sources due to their long service life and high energy efficiency. These are generally designed with a flat emitting surface. For the use of an LED in demanding photography, a minimum color rendering index, also known as a CRI value (CRI=Color Rendering Index), of 90 is required and for the highest demands even a CRI value of 95 to 98, which is already achievable with state-of-the-art LEDs.

The lateral extent of the light field should also be adjustable for object illumination. A circular light field, especially with a diameter range of 0.9 mm to 12 mm, has been recognized as very suitable for macro photography of small objects and object details. Light fields with any laterally extended shape such as stripes, triangles, polygons, stars, dot patterns or crescents—even in separate areas—are also very useful for modern macro photography. This is especially true when only certain details of an object are to be emphasized in the shot—such as the basket of a comparatively small flower blossom with a diameter of only about 8 mm. The light beam on the object should have a fairly good approximation to a flat top profile, i.e. be largely homogeneous, with little edge fall-off and sharp edges. Advanced macro photography also requires that the light field does not have a single halo or other unwanted light figures such as crescents, light spots or reflections from optical surfaces in the system and that stray light outside the light field is also negligible in terms of the resolution of macro photography.

Furthermore, when using very powerful LEDs with outputs equal to or even significantly above 20 watts, the waste heat from them is very detrimental to the object and the photographic equipment if an arrangement with one or more LEDs of this power class is placed in the immediate vicinity of the object to be photographed. Even an air flow for cooling does not always provide a remedy here, as very sensitive objects such as the delicate petals of a flower, for example, must not be exposed to an air flow, not even in the immediate vicinity. Fluttering or movement of fine, small objects caused by a current of air in the immediate vicinity of the object during shooting must be avoided at all costs.

In addition, the arrangement for generating the light field has been recognized as having a very advantageous free distance to the photographic object of at least 80 mm, preferably 100 mm and in extreme cases up to 200 mm, as large-volume photographic lenses are generally used, which require space in front of the object and the arrangement for generating the light field must not be visible in the object field to be photographed or restrict the free view of the object. This also results from the need to avoid casting a shadow of this arrangement on the object when using other light sources for photographic recording.

### STATE OF THE ART

With these aspects in mind, the state of the art for lighting in macro photography for the visible spectral range was researched.

On Sep. 4, 2022, the Swiss company Profot AG launched a fiber optic light guide kit as an accessory for the photographic sector under the Elinchrom brand. This can be connected to a fan-cooled Elinchrom flash lamp head using an adapter and guides the light to the object via a fiber optic light guide. The light can be slightly focused using a simple lens attachment. However, this only produces a blurred spot of light with a diameter of approx. 30 mm, which is far from adequate for the requirements of sophisticated macro photography.

On Apr. 7, 2022, the Polish company Godox offered the Godox S30 LED light as the basis for a modular system with 30 watts of electrical power consumption for table-top advertising photography, portrait photography or video recordings. This Godox S30 LED light, which has an integrated fan, can use the Godox SA-P1 projection attachment in conjunction with various projection lenses from the above-mentioned manufacturer with 60 mm, 85 mm or even 150 mm focal length and finely structured, interchangeable shading screens to produce focused and very finely structured light, especially at distances well above 0.5 meters. The maximum diameter of the illuminated aperture field in the Godox SA-P1 projection attachment is around 45 mm. This aperture field is reproduced sharply. This means that a wide variety of patterns can be projected relatively sharply using various shading screens of this size, and mobile, freely movable aperture blades can be used to illuminate almost any object details in a field of up to one square meter. The manufacturer refers to these movable aperture blades as frame shutters. However, even for the telephoto lens with 150 mm focal length, designated by Godox as SA-03 150 mm, the fully illuminated light field is always well above 50 mm in diameter. This is because a 1:1 image with the SA-03 150 mm telephoto lens is technically not even remotely possible without a considerably longer intermediate tube, which is not available from Godox or other manufacturers. Even a 1:1 reproduction of the aperture field of the Godox SA-P1 projection attachment would result in a light field of approximately 45 mm diameter. By using a small fixed shading aperture or a correspondingly small iris diaphragm, a light field in the form of a light spot with a diameter of only 4 mm, for example, can be projected by a strong dimming in the aperture plane of the Godox SA-P1 projection attachment. This is due to the limited optical modulation transfer function of the projection lenses available from Godox. However, these projected small light spots are comparatively weak for use in macro photography. This is because by stopping down the light field of 45 mm diameter to a small aperture in the lower single-digit millimeter range using a shading aperture, significantly more than 99% of the total light energy of the Godox S30 LED light is lost. This system based on the Godox S30 LED light with the offered projection attachment and the available projection lenses is therefore not at all a suitable system for macro photography with light fields of 0.9 mm to a maximum diameter of 12 mm and an illuminance significantly above 10,000 lux. It should be noted once again that, for physical-technical reasons, no compact, inexpensive standard projection lens can produce a spot with a diameter of 12 mm without any stopping down at a free distance of 100 mm from the apex of the front lens of this projection lens in a compact overall arrangement, starting from a light field with a diameter of 45 mm.

The Godox VSA-19K spotlight attachment kit offered on 06.04.2022 has a corrected lens system for light field projection for photo studio shots with object distances in the lower single-digit meter range and variously shaped, interchangeable and also specifically movable shading elements, which are projected sharply or with a gradient onto the object, for example onto the body of a human model. However, this system is not at all designed for macro photography, as it works with a widened, i.e. divergent, beam of light. Here, too, it is possible to create a circular light field, also known as a light spot, with a small diameter of just a few centimetres by means of a comparatively small shading aperture. However, from the point of view of macro photography, this light spot is still far too large and, above all, comparatively weak, as only a very small fraction of the luminous flux of this light field projector, for example well below 1%, then forms the small light spot in the lower single-digit centimeter range. In addition, the very powerful LED source of up to 300 W is mechanically attached directly to the light field projector, which can be very disturbing in macro photography due to the exhaust air from the cooling of the LED source at close range.

On Jun. 4, 2022, Scholly offered the powerful and versatile LED light sources FLEXILUX 4000 and FLEXILUX 7000, each with a fiber output, which have a color temperature of 5800 K and 6500 K respectively. These color temperatures mentioned above are not suitable for the specified application range of 5600 K and therefore exclude these light sources, as they are also unable to generate a small light spot at a free working distance of 100 mm.

LUMOLUX focusing attachments for light guides, consisting of a fiber bundle with LED light, were offered by the German company Faseroptik Henning on 9 Apr. 2022 to reduce the beam angle at the output of the light guide or to focus light. These focusing attachments consist of lens groups with spherical lenses, aspheres or plano-convex lenses. These collect the light and focus the light from the light guide output onto a circular light field. However, there are no focusing attachments available for light fields in the diameter range from 1 mm to 4 mm with a free distance of at least 80 mm. Furthermore, there is no aperture function to adjust the light field diameter. The focusing attachments are also quite slim and therefore remain well below the desired value of 0.12 for the numerical illumination aperture, even with the specified free working distances.

On Sep. 4, 2022, the German company SensoPart offered light guides with adjustable scanning ranges and light spot sizes for small part detection, especially for hole detection. There are also special optical attachments for different fixed and variable focus distances. With the focusable coaxial light guides, light spot sizes from 1.3 mm to 0.65 mm in diameter can be realized with single-colour light. However, the maximum working distance to the object is only 20 mm, which is not at all suitable for macro photography—in addition to the completely unsuitable light spectrum.

The Chinese company Shanghai Jinbei Photographic Equipment Limited Company with distribution in Germany had the extremely bright EFD-150 LED continuous light-5500 Kelvin on offer on 10.04.2022. This LED continuous light with 5500 Kelvin color temperature, a CRI value of over 97 and a power consumption of 150 W is offered without accessories for focusing. The radiating surface of the LED is a good 30 mm in diameter. This emitting surface is therefore rather too large for macro photography and is not suitable for this purpose in this form alone.

The HEDLER Profilux LED650 from the German company Hedler is an ultra-compact LED floodlight with continuous light.

This dimmable LED area light with 75 W power consumption generates light in daylight quality with a color temperature of approximately 5600K and a CRI value greater than 96 from a powerful LED with a single emitting surface. The emitting surface of the LED is approximately 20 mm in diameter. This emitting surface is therefore more suitable for macro photography than the much larger emitting surface of the EFD-150 LED continuous light from the Chinese company Jinbei [9]. Nevertheless, the HEDLER Profilux LED650 area light alone is not suitable for macro photography in this form for generating light fields of 12 mm diameter and smaller.

In U.S. Pat. No. 2,076,240 of 1934, FIG. 1 describes an arrangement for a projection apparatus for generating a light spot or floodlight with a bulb-shaped incandescent lamp 13 with a luminous filament 13b and a mirror 12 for collecting the emitted light in the form of part of a rotational ellipsoid—also for use in photography. In the area around the first focal point of the ellipsoid of revolution, which is not explicitly shown here, there is-clearly recognizable to the skilled person—the filament of the incandescent lamp 13, which radiates into the entire room, and in the area around the second focal point, which is also not explicitly shown, there is an iris diaphragm 29. This iris diaphragm is followed by an optical imaging stage with two identical plano-convex lenses in a tube, see FIG. 4, whose convex surfaces are turned towards each other to minimize aberrations in order to provide a sharp image of the opening of the iris diaphragm. Since LEDs with a flat emitting surface can only radiate into half space and only with a considerable drop in the lateral areas, the use of a mirror in the form of a part of a rotational ellipsoid is not very practical for an LED. In addition, a rotational ellipsoid only images the two focal points of a rotational ellipsoid into each other without aberrations, whereas when positioning a large-area LED in one focal point of the rotational ellipsoid, considerable aberrations occur when imaging into the second focal point if the rotational ellipsoid mirror is not very large in relation to the size of the LED. The use of a rotating ellipsoidal mirror in conjunction with a large-area LED is not a technically and economically sound solution under any circumstances. The iris diaphragm 29 in FIGS. 1, 6 and 7 is imaged using two plano-convex lenses 51 and 52 in a tube 26. The convex surfaces of the two plano-convex lenses 51 and 52 are turned towards each other in order to minimize aberrations. However, an imaging stage with only two plano-convex lenses is not well suited for generating sharply imaged light fields, i.e. light spots, in particular because of the chromatic aberrations that are not eliminated in this case. Even with a ratio of lens diameter to lens focal length of 0.4, very undesirable color fringes can occur with a boron glass lens material, depending on the light field size, which should be in the diameter range of a few millimeters. These are extremely disturbing for macro photography with the resolution of the smallest object details, whereby considerable edge blurring of the light field is also to be expected when only two plano-convex lenses are used.

DE 7607253U from 1976 describes a focusing attachment for flexible light guides that contains a converging lens for focusing. The converging lens can also be designed as an asphere. This is intended to reduce the angle of the light cone emitted from the light guide in order to concentrate the light. However, this arrangement using only a single lens does not produce a sharp-edged and largely homogeneous light field in the diameter range of a few millimeters without chromatic aberrations, which are very disturbing for macro photography. In addition, the lateral size of the light field cannot be adjusted.

### AIM OF THE INVENTION

The aim of the invention is to provide a teaching for an arrangement for generating a spaced, adjustable light field for macro photography, in particular also for object-adapted illumination with a sharp light field edge. This arrangement is to be put to commercial use.

### TASKS OF THE INVENTION

The invention is based, among other things, on the task of providing an improved arrangement for an adjustable light field for macro photography for object-adapted illumination with a high illuminance and a light distribution that is as uniform as possible and with a sharp light field edge.

In particular, the light field size should be adjustable between 0.9 mm and 12 mm in diameter and the free working distance to the photographic object should be at least 80 mm, preferably 100 mm and in extreme cases up to 200 mm. For a half-value diameter HWD (Emax), related to the maximum illuminance Emax, of a circular light field in the diameter range from 0.9 mm to 12 mm, this light field should appear to the normal eye from the clear visual distance of 250 mm with a sharp light edge. No color fringes should be perceptible at the edge of this light field and no disturbing reflections from optical surfaces and no disturbing halos should be visually discernible in the vicinity of the light field.

In order to achieve a high illuminance E in the light field, the numerical aperture of the illumination light beam for a free working distance of 100 mm to the photographic object should be greater than or equal to 0.12. This corresponds to a full angle of the light cone to a single point in the light field on the optical axis of approximately 14°.

Lighting should preferably be permanent. As a result, it should not be flash lighting. Furthermore, a very high illuminance in the upper five-digit lux range and in extreme cases up to the lower or even middle six-digit lux range with a defined color temperature of 5600K+/−100K and a Color Rendering Index of at least 90, better above 96, should be achieved with continuous light in the light field for object illumination for macro photography. The high-performance LED light source to be used with forced ventilation, which is generally indispensable in the state of the art, should be at least one meter away from the object for macro photography, even if the fan of the light source is comparatively quiet, so that residual air currents cannot cause any movement, fluttering or vibrations of the photographic object. This is particularly important if the photographic object is wafer-thin, film-like or spider-web-like. The design of the arrangement for generating a spaced, adjustable light field for macro photography should be feasible, in particular using inexpensive optical components from the mass market, and this with a compact design, especially in the front area of the arrangement where the light emerges in the direction of the photographic object.

In addition, the design of the arrangement and in particular the imaging stage should have the smallest possible outer diameter. This means that the maximum outer diameter should in any case be smaller than 1.6 times the largest lens diameter, preferably even smaller than 1.4 times the largest lens diameter in the imaging stage that is to contain the largest lenses.

### DESCRIPTION OF THE INVENTION

The invention relates to an arrangement for generating a spaced, adjustable light field for macro photography, in particular for object-adapted illumination with a sharp light field edge and with a light field with a lateral extent of at least 0.9 mm or more and a maximum lateral extent of 12 mm or less for illuminating small objects and small object details. The following components are arranged in this configuration:
an LED which is designed as a continuous light LED with at least 20 W electrical power consumption and a CRI greater than or equal to 90,
an optical coupling module,
a light guide, which is configured as a fluid light guide with a diameter of the optically usable range between 2.5 mm and 10 mm, which is also referred to by experts as a liquid light guide, which is arranged downstream of the optical coupling module,
a diaphragm tube which is formed with a high-aperture, asymmetrical condenser lens and with at least one shading aperture arranged downstream of the high-aperture, asymmetrical condenser lens, the image of which is the light field, and
an imaging stage downstream of the diaphragm tube for an amount of the magnification beta′ when imaging the shading aperture between 0.7 and 2.

The optical coupling module, which is used to couple light from the continuous light LED into the fluid light guide, is designed with two positive and asymmetrically designed aspherical lenses with a numerical aperture greater than or equal to 0.4. The magnitude of the paraxial magnification of the optical coupling module beta_pK′ is between 0.5 and 1.2. The fluid light guide is at least 0.8 m long and is arranged between the optical coupling module and the diaphragm tube and the exit window of the fluid light guide is arranged at least approximately in the front focal plane of the high-aperture, asymmetrical condenser lens. The high-aperture, asymmetrical condenser lens in the diaphragm tube has a focal length of 4 mm or more and 24 mm or less and its numerical aperture is always greater than or equal to 0.4. The more strongly curved lens surface of the high-aperture, asymmetrical condenser lens is turned towards the shading aperture. The high-aperture, asymmetrical condenser lens also makes it possible to illuminate a shading aperture quite uniformly, the diameter of which is larger than the diameter of the light guide. The effect of the high-aperture, asymmetrical condenser lens causes a large proportion of the light to be directed into the imaging stage after passing through the shading aperture. As a result, the imaging of the shading aperture through the imaging stage produces a fairly uniformly illuminated light field.

The imaging stage is designed with at least one light-collecting, achromatic lens group with a lens diameter of 38 mm or more to generate a sharply defined light field by means of optical imaging. The light field is created as a result of the imaging of the shading aperture. This light field for use in macro photography is therefore created by imaging the shading aperture using at least one light-collecting, achromatic lens group. The free working distance a, or aL, to the light field from the front mechanical stop of the mount of the imaging stage is greater than or equal to 80 mm.

For thermal reasons, the optical coupling module between the continuous high-power LED and the fluid light guide is indispensable, as a continuous high-power LED in the range of 20 watts or significantly more continuous power, for example 100 watts, cannot be placed directly upstream of the fluid light guide in continuous operation without the risk of the fluid light guide being destroyed by heat. In contrast, a lens made of optical glass directly downstream of the high-power continuous light LED can withstand this heat input in continuous operation if it has a suitable mechanical mount, which may also have a heat sink. In extreme cases, the lens directly downstream of the continuous high-power LED can also be made of quartz glass, which is particularly insensitive to strong heating.

The edge sharpness of the light field is defined in the context of this invention. The illuminance E of the light field forms a curve over the radius r of the light field, at least approximately in the shape of a hat, which already approximates quite well to an upright rectangle with somewhat rounded edges. A light field is considered to have a sharp edge if, for the imaging stage with a diameter of the light field of one millimeter up to 12 millimeters, the number of transmissible line pairs with a line contrast K of 0.5 in the edge area of this light field is at least 10, i.e. the line contrast K in the edge area of this light field is greater than or equal to 0.5 for 10 line pairs per millimeter. With this definition of the edge sharpness, the image field curvature, which can already exist with comparatively simple illumination optics, therefore plays a rather subordinate role, at least if the light field is circular and centered to the optical axis of the illumination optics. This also applies to the distortion of the illumination optics, which is less or not at all negatively noticeable for this illumination task.

Preferably, in the arrangement for generating a spaced, adjustable light field for macro photography, the imaging stage is designed with only a single light-collecting, achromatic lens group. This light-collecting, achromatic lens group is then preferably designed as a light-collecting achromatic triplet. Such a triplet can be formed with cemented lenses or without cemented lenses. A cemented triplet is preferred due to the lower light losses. Preferably usable triplets are especially those according to Steinheil, but triplets according to Hastings and Cooke can also be preferably used.

Preferably, a pair of light-collecting, cemented, achromatic lens doublets can also be used in the imaging stage instead of just one light-collecting, achromatic lens group. For illumination purposes in macro photography, this already results in a sufficiently good to very good imaging quality for the light field, which represents the optical image of the illuminated shading aperture. However, the imaging stage can also preferably be designed with two light-collecting, uncut, achromatic lens doublets, i.e. of the Fraunhofer type. An imaging stage with uncemented, achromatic lens doublets generally outperforms an imaging stage with light-collecting, cemented, achromatic lens doublets in terms of imaging quality. However, uncemented achromatic lens doublets have a slightly lower light transmission compared to cemented doublets and are only available on the market in a limited range as a mass product.

However, it should be noted that all optics manufacturers only offer inexpensive, light-collecting, cemented, achromatic lens doublets in a comparatively coarse graduation of focal lengths and diameters. This means that not every working distance is possible, for example a working distance of 100 mm from the mount of the imaging stage with an exact 1:1 image of the light field, if, for example, there is a typical distance of approximately 5.5 mm between the lens apex of the last lens and the mount due to the design. Customized development and production of light-collecting, cemented, achromatic lens doublets, whose focal length is adapted exclusively for a small series, is generally not an alternative for cost reasons.

However, it is also possible in principle to use a pair of triplets according to Steinheil or Hastings as a light-collecting, achromatic lens group instead of just one light-collecting, achromatic lens group for imaging the illuminated shading aperture. However, the selection of suitable triplets on the mass market is also very limited, and these usually far exceed the cost of a cemented achromatic lens doublet from the mass market, especially with a lens diameter of 38 mm and larger. Here, too, it is particularly true that the customized production of triplets for a small series is generally no alternative at all to light-collecting, cemented, achromatic lens doublets from the mass market for cost reasons.

Preferably, in the arrangement for generating a spaced, adjustable light field for macro photography in the imaging stage, instead of only one light-collecting, achromatic lens group, two light-collecting, cemented achromatic lens doublets with the optical design are each formed on one side for a beam path to infinity with a focal length greater than/equal to 80 mm and less than/equal to 200 mm.

Furthermore, the light-collecting, cemented achromatic lens doublets with spherical lenses are preferably used here as light-collecting, achromatic lens groups. These lens doublets are usually formed with an optical design on one side towards infinity and are commercially available in a wide range on the mass market and enable an optical design with reduced aberrations. The more strongly curved lens surfaces of the two light-collecting, cemented achromatic lens doublets are turned towards each other in an arrangement to create a spaced, adjustable light field for macro photography.

Furthermore, the two light-collecting, cemented achromatic lens doublets in the imaging stage of the arrangement for generating a spaced, adjustable light field for macro photography preferably have a different focal length, which is greater than or equal to 80 mm in each case, and the ratio of their focal lengths can preferably be between 0.7 and 2.

Furthermore, it is possible that in the arrangement for generating a spaced, adjustable light field, the two light-collecting, cemented, achromatic lens doublets in the imaging stage preferably each have a focal length of 120 mm. When the shading aperture is in the focus of the first achromatic lens doublet, this enables a free working distance a-depending on the design of the imaging stage—of approximately 105 mm to 110 mm. In particular, a diameter of these cemented achromatic lens doublets of 50 mm results in a very high illuminance in the light field, even if the edge sharpness is no longer very good. If necessary, an aperture diaphragm can be used in, before or after the imaging stage to stop down a little, for example to a diameter of 40 mm, in order to achieve better edge sharpness. However, cemented achromatic lens doublets with a diameter of 40 mm can also be used.

Furthermore, it is possible that in the arrangement for generating a spaced, adjustable light field, preferably one of the two light-collecting, cemented, achromatic lens doublets in the imaging stage has a focal length of 100 mm and the other has a focal length of 120 mm. This allows the free working distance to be set to less than 110 mm.

Furthermore, it is possible that in the arrangement for generating a spaced, adjustable light field, the first of the two light-collecting, cemented, achromatic lens doublets in the imaging stage preferably has a focal length of 100 mm and the second lens doublet in the imaging stage preferably has a focal length of 120 mm and the shading aperture is not arranged in the focal point of the first, cemented, achromatic lens doublet. In this way, an extrafocal position can exist with the shorter focal length, light-collecting, cemented, achromatic lens doublet and an intrafocal position with the longer focal length doublet when imaging the shading aperture. This combination of light-collecting, cemented, achromatic lens doublets with an intrafocal or extrafocal position of the shading aperture and light field also permits a 1:1 image of the shading aperture, which is still acceptable for an illumination task in terms of imaging quality.

Furthermore, it is possible that in the arrangement for generating a spaced, adjustable light field, the shading aperture is preferably arranged with an extrafocal position af to the focal point of the first light-collecting, cemented, achromatic lens doublet in the imaging stage with an amount af of up to 15 mm, if the focal length of the achromatic lens doublets in the imaging stage is between 100 mm and 120 mm. Although this does not result in a very good image of the shading aperture and this is also somewhat worse than with the focal position of the same, this slightly asymmetrical arrangement is generally still suitable for achieving a line contrast K in the edge area of the light field greater than or equal to 0.5 for 10 line pairs per millimeter if the out-of-focus deposit af is in the order of magnitude with the amount less than 15 mm and the light field has a diameter less than or equal to 12 millimeters. Typically, however, the distance af to the focal point should preferably be less than 10 mm.

In a further aspect, the two light-collecting, cemented, achromatic lens doublets in the imaging stage are preferably accompanied by a thin additional lens, the amount of refractive power of which is preferably between 0.5 diopters and 2.0 diopters. This combination of two light-collecting, cemented, achromatic lens doublets and a thin additional lens, which is arranged separately from the two lens doublets, basically enables an image with a magnitude of the magnification of one with a good approximation, for example with a deviation from the magnitude of one in the lower single-digit percentage range, if the refractive power of this additional lens is selected accordingly. This can be achieved by a positive refractive power of this thin additional lens, which leads to a reduction in the free distance from the last light-collecting, cemented, achromatic lens doublet to the light field. A reduction in the free distance also results in a very desirable increase in illuminance in the light field.

However, a thin additional lens with negative refractive power can also be used to increase the free distance from the last light-collecting, cemented, achromatic lens doublet to the light field. This can be useful if the two light-collecting, cemented, achromatic lens doublets only have a focal length of 100 mm. A greater amount of refractive power of the thin additional lens than 2.0 diopters usually leads to intolerable spherical aberration and color errors in the image of the shading aperture, whose image is the light field. As a result, the requirement for the line contrast K in the edge area of the light field greater than or equal to 0.5 for 10 LP/mm can no longer be met with certainty, whereby the light field here has a diameter of less than or equal to 12 millimeters.

It is advantageous if the material of the thin additional lens is preferably manufactured with an Abbe number greater than or equal to 56. This is because a high Abbe number causes fewer undesirable chromatic effects due to low color dispersion and thus reduces the risk of color fringing at the edge of the light field, which is very undesirable. The requirement for the line contrast K at the edge of the light field to be greater than or equal to 0.5 for 10 LP/mm can therefore also be better fulfilled.

A particularly advantageous arrangement is obtained if the thin additional lens is preferably designed as a converging lens in the arrangement for generating a spaced, adjustable light field. This results in a somewhat greater illuminance and it is possible to set a precisely predetermined free distance aL by selecting the refractive power of this converging lens, as these converging lenses are available in very fine gradations in terms of their refractive power and are inexpensive in the field of spectacle optics. This is because the available inexpensive light-collecting, cemented, achromatic lens doublets as catalog goods are only available with a comparatively coarse gradation of the values of the available focal lengths, so that a required free distance aL to the light field cannot always be achieved exactly with these. This also applies in the case of a free distance aL to the light field of 100 mm.

On the other hand, the thin additional lens can preferably also be designed as a diverging lens. This makes it possible to set a precisely predetermined but larger free distance aL—than with the two light-collecting, cemented, achromatic lens doublets alone.

The thin additional lens can preferably also be in the form of a meniscus. In this case, the belly of each lens preferably faces a light-collecting, cemented, achromatic lens doublet. This minimizes aberrations when imaging the shading aperture.

The thin additional lens can preferably be made of the low-cost thermosetting plastic polyallyl diglycol carbonate (CR-39) for spectacle lenses and is preferably a spectacle lens. This thermosetting plastic CR39 has an Abbe number of 58 and therefore has a comparatively low dispersion.

However, the thin additional lens can also preferably be made of mineral glass with an Abbe number greater than or equal to 56 and is also preferably a spectacle lens. Lenses made of mineral glass prove to be somewhat more scratch-resistant and dimensionally stable than lenses made of a thermosetting plastic.

If the thin additional lens in meniscus form is arranged in the imaging stage in the beam direction in front of the first light-collecting, cemented, achromatic lens doublet preferably with its lens belly towards the first light-collecting, cemented, achromatic lens doublet, this reduces the aberrations when imaging the shading aperture.

Furthermore, the thin additional lens in meniscus form can preferably be designed with a refractive power of +1.5 diopters in order to generate a spaced, adjustable light field for macro photography. In conjunction with two light-collecting, cemented, achromatic lens doublets—preferably with a focal length of 120 mm—this can enable a free working distance aL of approximately 100 mm with a magnification of the imaging stage of one. The arrangement of a thin additional lens as a converging lens and in meniscus form also results in slightly improved light yield by increasing the numerical aperture and introduces only minor aberrations into the imaging stage with two light-collecting, cemented, achromatic lens doublets.

Furthermore, in the arrangement for generating a spaced, adjustable light field for macro photography, the high-aperture converging lens can be designed with a numerical aperture of 0.8 and a positive focal length equal to 7.5 mm. This results in a high illuminance in the light field when imaging the shading aperture with a diameter of a circular shape or a lateral extension of any shape less than or equal to 8 mm.

In the case of a shading aperture with a diameter for a circular shape or a lateral extension for any shape greater than or equal to 8 mm, the high-aperture converging lens is preferably designed with a numerical aperture of 0.8 and a positive focal length equal to 20 mm. This results in an adapted illuminance in the light field when imaging the shading aperture.

It is a great advantage if at least one LED with a CRI value greater than or equal to 95 is preferably arranged as a lighting element in the arrangement for generating a spaced, adjustable light field for macro photography. This already approximates correct color rendering quite well. However, it is better to use an LED with a CRI value of 97 or even 98.

Furthermore, in the arrangement for generating a spaced, adjustable light field for macro photography, the LED is preferably designed as a single-cell LED, which is preferably circular. This enables a particularly homogeneous light field.

The risk of creating a very undesirable halo around the light field is very high in an arrangement for generating a spaced, adjustable light field for macro photography if the clear diameter in the aperture module immediately downstream of the shading aperture is too small, even if the inside of the diaphragm tube is blackened. A halo occurs when the light is reflected grazingly at the diaphragm tube immediately after the shading aperture, i.e. comparatively far away from the lens optics, which is greatly facilitated by a small clear width of the diaphragm tube. Preferably, therefore, the clear width of the diaphragm tube should at least correspond to the diameter of the first light-collecting, cemented, achromatic lens doublet. Preferably, the clear diameter in the imaging stage in front of this first light-collecting, cemented, achromatic lens doublet should also correspond at least to the diameter of the same. This prevents the formation of a halo around the light field.

It is of great advantage with regard to the flexibility of the arrangement for generating a spaced, adjustable light field for macro photography if the shading aperture is preferably designed as an adjustable iris diaphragm. This allows the diameter of the light field—depending on the design of the iris diaphragm—to be set within wide limits, preferably in the range from 1 mm to 12 mm.

Furthermore, in the arrangement for generating a spaced, adjustable light field for macro photography, the shading aperture is preferably designed with at least two slidable, flat diaphragm blades. This allows the light field to be narrowed in order to illuminate only certain details of the photographic object, for example an object edge, during macro photography.

There is even more flexibility in macro photography if the shading screen is preferably designed as a flat thin sheet that can be inserted and is freely designed with openings in the arrangement for creating a spaced, adjustable light field for macro photography. This allows details to be specifically illuminated. For this purpose, an object-adapted thin sheet can be produced as a shading screen for a specific photographic object using computer-aided processing.

In the arrangement for generating a spaced, adjustable light field for macro photography, the flat, retractable shading screen can preferably also be designed with several openings in the sheet metal, which are not connected. This shading screen can also preferably have a honeycomb structure. In this way, several different areas on the photographic object can be illuminated individually. This shading screen can preferably be manufactured to suit the object, for example to check series products for defects in transit.

Preferably, in addition to the two achromatic, light-collecting lens groups, an achromatic, light-collecting lens group with a focal length greater than or equal to 250 mm and less than 750 mm is arranged in the imaging stage. Compared to a thin lens, this can improve the imaging performance of the imaging stage and thus also the edge sharpness of the light field.

Preferably, in the arrangement for generating a spaced, adjustable light field for macro photography, the imaging stage is designed with only one light-collecting, achromatic lens group. Preferably, only a single light-collecting, cemented, achromatic lens doublet with preferably spherical lens surfaces can be arranged in the imaging stage for at least an approximate 1:1 image of the shading aperture. However, this very simple arrangement is only suitable to a very limited extent for generating a sharp-edged light field, especially with an achromatic lens doublet corrected to infinity, but can be used as a comparatively inexpensive arrangement while accepting a comparatively low imaging quality. Preferably, this single light-collecting, cemented, achromatic lens doublet can also have a thin additional lens. This thin additional lens is preferably arranged on the side with the greater lens curvature of the light-collecting, cemented, achromatic lens doublet and can also preferably be designed in the form of a meniscus. This then distributes the refractive power required to image the shading aperture, which can be designed as an iris diaphragm, over two optical components, which can further improve the imaging quality of the imaging stage. Preferably, however, one lens surface in this individually used light-collecting, cemented, achromatic lens doublet can also be aspherical, which can increase the imaging quality with an at least approximate 1:1 imaging of the shading aperture if this light-collecting, cemented, achromatic lens doublet is specially designed for this in the optical calculation. For image processing, such a light-collecting, cemented, achromatic lens doublet is rather unknown, as the image quality of this modified doublet is generally no longer sufficient for image processing in the state of the art.

Cemented, achromatic lens doublets with spherical lens surfaces and a one-sided design to infinity are offered by several manufacturers at comparatively low cost, as they are also frequently used in commercially available binoculars. These standard lens doublets usually have an asymmetrical design with a more curved lens surface on one side and this side is designed for infinity. If this more strongly curved lens surface of this achromatic lens doublet is assigned to the shading aperture, the distance of the lens apex to the shading aperture is approximately twice the focal length of this lens doublet for a 1:1 image of the shading aperture. For a focal length of this achromatic lens doublet of 60 mm and a diameter of 40 mm, the distance of the lens apex to the shading aperture is therefore approximately 120 mm. It is also possible that the less curved side of this light-collecting, cemented, achromatic lens doublet points towards the shading aperture. In this case, the usual asymmetrical design of the cemented achromatic lens doublets with a focal length of 60 mm and a diameter of 40 mm is only approximately 110 mm due to the position of the main plane deep inside the achromatic lens doublet. The requirement for the line contrast K in the edge area of the light field greater than or equal to 0.5 for 10 LP/mm can in many cases—depending on the optical design and layout of the arrangement, especially with a cemented, achromatic lens doublet with a focal length significantly greater than 60 mm—just about be met. If not, the diameter of the cemented achromatic lens doublet must be reduced to around 25 mm, for example, or the focal length must be significantly increased, for example to 90 mm.

As already mentioned, a significant improvement in image quality can result from the use of an achromatic lens doublet with an aspherical lens surface if this lens doublet is optimized for imaging with the magnitude of the magnification between 0.7 and 2 and in particular for 1:1 imaging for illumination purposes. However, comparatively inexpensive achromatic lens doublets from the mass market with an aspherical lens surface are generally corrected to infinity and are not available as a mass product, since the imaging quality of a single achromatic lens doublet is generally still too low for 1:1 imaging, even with an aspherical surface for image processing tasks. Preferably, for illumination purposes, the optical design can be optimized for a single light-collecting, cemented, achromatic lens doublet with an aspherical lens surface, but also for imaging with the magnitude of the magnification between 0.7 and 2. This represents a considerable compromise in terms of imaging quality, but can still be tolerable for the generation of a light field for illumination purposes. It can therefore be advantageous if at least one lens surface of a light-collecting, achromatic lens group in the imaging stage is formed with an aspherical surface in the arrangement for generating a spaced, adjustable light field for macro photography. This aspherical surface can preferably be produced using a plastic coating. This can increase the imaging performance and therefore also the edge sharpness of the light field. In particular, an aspherical surface can be used on a light-collecting, cemented, achromatic lens doublet if only a single achromatic lens doublet is arranged in the imaging stage for imaging with the magnitude of the magnification between 0.7 and 2.

In a further aspect, a triplet achromat with a diameter of at least 38 mm and a focal length of at least 50 mm can preferably be arranged in the arrangement for generating a spaced, adjustable light field for macro photography in the imaging stage. This can be a triplet achromat according to Steinheil, Cooke or Hastings. The triplet achromat is used to form a sharply edged light field, which is created as a result of the imaging of the shading aperture.

Furthermore, in the arrangement for generating a spaced, adjustable light field for macro photography, the triplet achromat can preferably be designed as a cemented Steinheil triplet achromat with a focal length of at least 50 mm. This Steinheil triplet achromat is then preferably used with a magnification of at least approximately 1 at a focal length of approximately 60 mm. This enables good imaging quality for a light field. However, a Steinheil triplet for a diameter equal to or greater than 40 mm is only available as a custom-made product in the state of the art and is therefore not very cost-effective.

Furthermore, two cemented Steinheil triplet achromats with a diameter of at least 38 mm and with a focal length of 80 mm or more and 200 mm or less can also be arranged in the arrangement to create a spaced, adjustable light field for macro photography. This enables a particularly good image quality for a light field.

Furthermore, two cemented Hastings triplet achromats with a diameter of at least 38 mm and with a focal length of 80 mm or more and 200 mm or less can also be arranged in the arrangement to create a spaced, adjustable light field for macro photography. This also enables a particularly good image quality for a light field. Here too, however, Hastings triplets with a diameter equal to or greater than 38 mm are not available on the market as mass-produced goods at the current state of the art. This means that a custom-made product is necessary and Hastings triplet achromats are therefore not available at very low cost.

The shading aperture can preferably be arranged at least approximately in the rear focal plane of the high-aperture, asymmetrical condenser lens. Since the fluid light guide—with its exit window located in the front focal plane of the high-aperture, asymmetrical condenser lens—emits the light very uniformly, a uniform light distribution can result in the rear focal plane of the high-aperture, asymmetrical condenser lens, even if particles, scratches or even small outbreaks are located on the exit window of the fluid light guide. Due to the preferred position of the shading aperture in the rear focal plane of the high-aperture, asymmetrical condenser lens, the illuminance from the center to the edge of the illuminated field is reduced only comparatively slightly and is particularly uniform, which is very advantageous for illuminating an object for macro photography.

### DESCRIPTION OF THE FIGURES

The invention is described by way of example with reference to FIGS. 1 to 11 and with 5 embodiments without figure.

FIG. 1 shows an arrangement for generating a sharply edged light field with a free working distance of 110 mm. The continuous light source 10 has a power supply 11 with a power consumption of 75 W from the ultra-compact HEDLER Profilux LED650, which supplies the high-power single-cell LED 12. White light with a color temperature of 5600K and a Color Rendering Index (CRI) greater than 96 is emitted from the high-power single-cell LED 12. This light enters the optical coupling module 20, which has the two high-intensity aspherical lenses 21 and 22. These aspherical lenses 21 and 22 are also shown again in FIG. 9 and explained in their description. The coupling module 20 makes it possible to focus the light from the LED 12 into the entrance window 31 of the fluid light guide 30. The light enters the diaphragm tube 40 via the fluid light guide 30 and its exit window 32, in the center of which the front focal point F41 of the high-aperture, asymmetrical condenser lens 41 is located. The lens 41 in the diaphragm tube 40 collects the light emerging from the exit window 32, which fully illuminates the aperture plane BE. The shading aperture 42 is arranged in the rear focal point F41′ of the high-aperture, asymmetrical condenser lens 41. This shading aperture 42 is designed here as a fixed diaphragm for special tasks and has a diaphragm diameter of 1 mm. Downstream of the diaphragm tube 40 with the shading aperture 42 is the imaging stage 50, which is designed here with the two light-collecting, cemented, achromatic lens doublets 51 and 52 for an image scale beta′ with a magnitude of 1. These two light-collecting, cemented, achromatic lens doublets 51 and 52 are offered by the company Qioptic under the designation Achromat VIS, positive, unmounted with the order number G322388000, each with a diameter of 40 mm and a focal length f′ of 120 mm. The shading aperture 42 is positioned at the front focus F51 of the light-collecting, cemented, achromatic lens doublet 51 and this results in the position of the light field 60 at the rear focus F52′ of the light-collecting, cemented, achromatic lens doublet 52. The light field 60 is shown enlarged here for reasons of clarity. The apex focal length s52′ of the light-collecting, cemented, achromatic lens doublet 52 is 113.6 mm here. The distance from the image-side apex S52′ to the front mechanical stop 53 of the mount of the imaging stage 50 is approximately 5.5 mm. This results in an approximate free working distance a=108 mm between the front stop 53 of the mount of the imaging stage 50 and the light field 60 in the plane LSE. The light field 60 with the half-value diameter HWD is created in the plane LSE with the best edge sharpness. There is also an object, not shown here, for the photographic macro shot, which is taken using a photographic lens 70 whose focal plane SE contains the light field 60 at least approximately. The area in front of the front lens 71 of the photographic lens 70 is not shadowed by the imaging stage 50 due to the comparatively large free distance a of 108 mm and there is no mechanical contact between the imaging stage 50 and the photographic lens 70 in area A, which represents the area with possible space problems. These space problems can exist between the front lens 71 of the photographic lens 70 and the front area of the imaging stage 50 when generating a light field 60 if the free distance is too small.

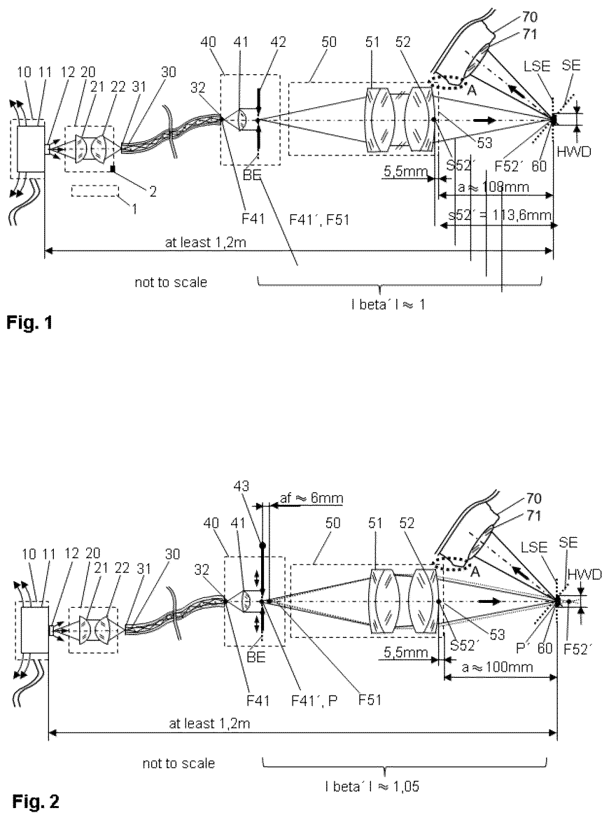

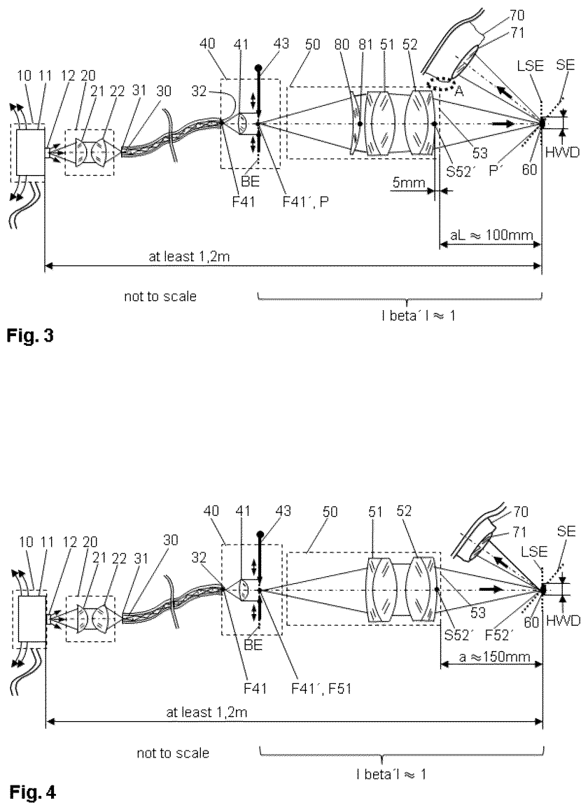

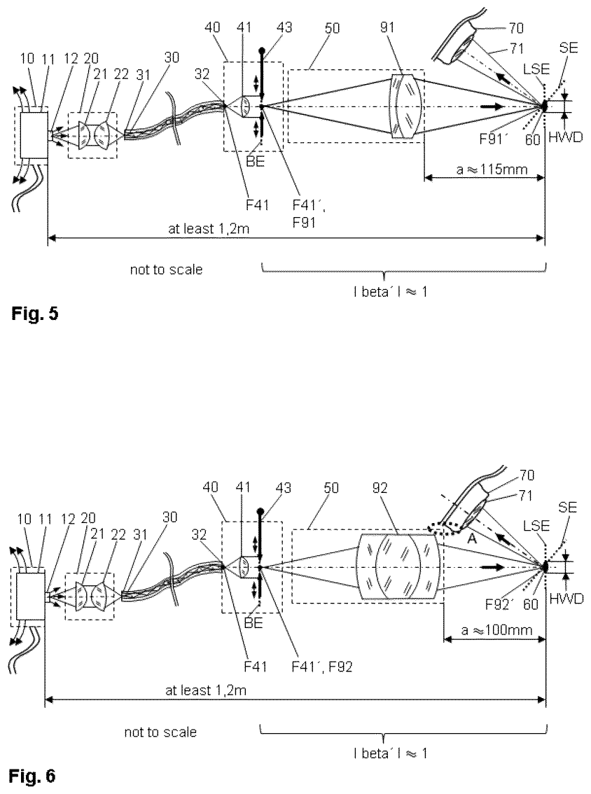

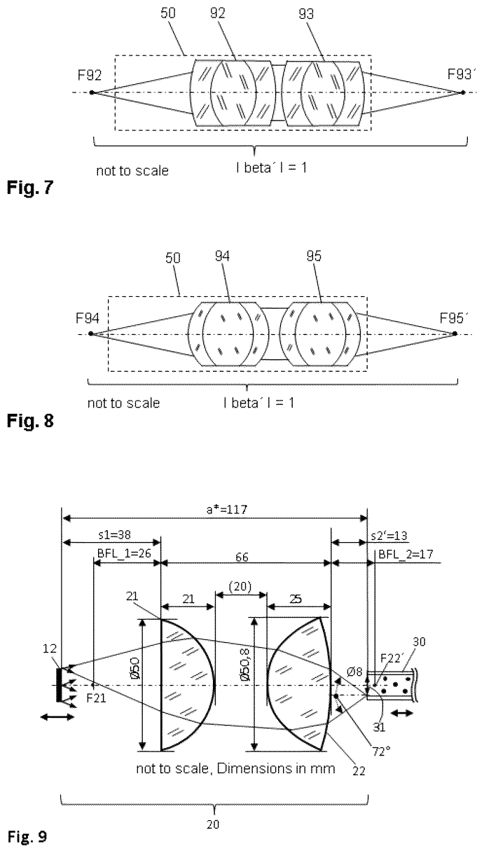

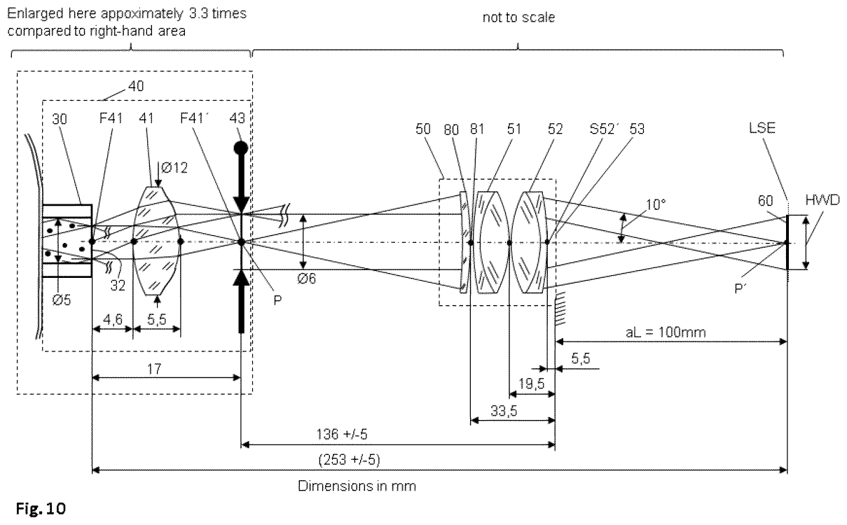

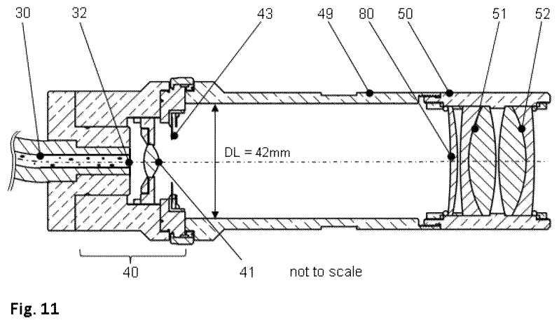

In a first embodiment example according to FIG. 1, but without a separate figure, two light-collecting, cemented, achromatic lens doublets 51 and 52, each with a focal length of 100 mm, are arranged in the imaging stage 50. This results in a free working distance a of slightly less than 90 mm for an image with a magnification of 1 due to the position of the image-side main plane in the depth of the cemented, achromatic lens doublet 52. However, this free working distance a of less than 90 mm is already considered too small for optimal macro photography with large SLR cameras in many shooting situations.

In FIG. 2, two light-collecting, cemented, achromatic lens doublets 51 and 52 with slightly different focal lengths are arranged in the imaging stage 50. The lens doublet 51 has a focal length of f51′=100 mm and the light-collecting, cemented, achromatic lens doublet 52 has a focal length of f52′=120 mm. The shading aperture 42 is designed here as an iris diaphragm 43 with a minimum diaphragm diameter of 1 mm. The desired free working distance a of the light field 60 from the front mechanical stop 53 of the mount of the imaging stage 50 of approximately 100 mm is achieved by a comparatively small extrafocal position af of the iris diaphragm 43—in relation to the focal point F51—of approximately af=6 mm. The extrafocal position af denotes the distance to a focal point F. The light field 60 is then located intrafocally on the image side in relation to the focal point F52′ of the second light-collecting, cemented, achromatic lens doublet 51. This results in an approximate magnification of 1.05. The small extrafocal position af of the iris diaphragm 43 slightly worsens the image quality compared to the focal position. However, we are dealing here with illumination optics and not with imaging with the image quality requirements of photography or even microscopy, so this deterioration in image quality can generally still be accepted.

In a second embodiment example according to FIG. 2, but without a separate figure, the first light-collecting, cemented, achromatic lens doublet 51 with a focal length f51′ of 120 mm and the second light-collecting, cemented, achromatic lens doublet 52 with a focal length f52′ of 100 mm are formed in the imaging stage 50. Here, too, it is possible to set a free working distance a of the light field 60 from the front mechanical stop 53 of the mount of the imaging stage 50 of approximately 100 mm, but the intrafocal afocal distance af in relation to the focal point F51 then already significantly exceeds the value of 10 mm, which is not necessarily advantageous for the imaging quality, but is usually still tolerable for the lighting task. Also, an amount of the magnification beta′ of the iris diaphragm 43 cannot be achieved with a good approximation to one—i.e. in the range of an approximation of less than 1%.

FIG. 3 shows a further arrangement for generating a sharply edged light field 60 with a free working distance a of 100 mm. The focal length of the light-collecting, cemented, achromatic lens doublets 51 and 52 in the imaging stage 50 is f51′=f52′=120 mm in each case. In contrast to the embodiment example in FIG. 1, a thin additional lens 80 is arranged here in the imaging stage 50. This additional lens 80 is designed here as a collecting, anti-reflective spectacle lens in meniscus form with a refractive power of +1.5 diopters and is made of the thermosetting plastic polyallyl diglycol carbonate (CR-39) for spectacle lenses, which has an Abbe number of 58. This type of spectacle lens is comparatively inexpensive and easy to obtain.

In a third embodiment example without figure, a thin converging lens with a refractive power of +1.25 diopters, or a focal length of 800 mm, is arranged centrally between the two light-collecting, cemented, achromatic lens doublets 51 and 52, each with a focal length of f51′=f52′=120 mm in the imaging stage 50. This lens is manufactured as an anti-reflective spectacle lens made of mineral glass and has a refractive index of 1.5. This arrangement also approximates the magnitude of the magnification well to one and also enables a free working distance aL of the light field 60 from the front mechanical stop 53 of the mount of the imaging stage 50 of approximately 100 mm.

In a fourth embodiment example without figure, a thin diverging lens, i.e. with a negative refractive power, is arranged as a front lens in meniscus form in front of the two light-collecting, cemented, achromatic lens doublets 51 and 52 with focal lengths f5l′ and f52′ of 120 mm each in the imaging stage 50. Although this slightly reduces the free working distance to the light spot 60 due to their thickness and mount, it allows the front lens to be changed quickly if the free working distance aL is to be significantly increased, for example to 130 mm. However, a reduction in the illuminance of the light field 60 must be accepted. The refractive power of this front lens is then approximately-1.5 diopters. However, there is then no longer a 1:1 image, but a moderate enlargement of the light field 60.

FIG. 4 shows an arrangement for generating a sharply edged light field 60 with a free working distance of 150 mm. A thin additional lens is not used here. Two light-collecting, cemented, achromatic lens doublets 51 and 52, each with a focal length f51′ and f52′ of 160 mm, are arranged in the imaging stage 50.

FIG. 5 shows an arrangement with only a single light-collecting, cemented, achromatic lens doublet 91 in the imaging stage 50. This light-collecting, cemented, achromatic lens doublet 91 has a focal length f91′ of 60 mm and a diameter of 40 mm. However, the image quality is quite limited.

FIG. 6 shows an arrangement with a Steinheil triplet 92, which can be used in imaging stage 50. The imaging quality with a Steinheil triplet 92 far exceeds that with only a single light-collecting, cemented, achromatic lens doublet 91.

FIG. 7 shows an arrangement with two Steinheil triplets 92 and 93, which can be used in the imaging stage 50 and which can improve the imaging quality somewhat compared to an arrangement with only one Steinheil triplet.

FIG. 8 shows an arrangement with two Hastings triplets 94 and 95, which can be used in the imaging stage 50 and which also enable a high imaging quality.

FIG. 9 shows an optical coupling module 20 with two high-intensity aspherical lenses 21 and 22, whereby only one lens surface is aspherical in each case. These aspherical lenses 21 and 22 are shown here with their lens bellies facing each other. The aspherical lenses used are supplied by Thorlabs with the designations ACL5040U-A and ACL50832U-A. These have numerical apertures of 0.6 and the latter of 0.76. This optical coupling module 20 can be used for a paraxial magnification beta_pK′ of 0.5 to 1 by setting the high-power single-cell LED 12 and the liquid light guide 30 with its entrance window 31 in the corresponding depth position. Taking into account the paraxial magnification beta_pK′ and the imaging power of the optical coupling module 20, the high-power single-cell LED from Hedler from the continuous light source HEDLER Profilux LED650 with a diameter of 18.5 mm is used here as LED 12. The Lumatec fluid light guide 30 from the 380 series has a diameter of 8 mm and a length of 2m. The illumination of the entrance window 31 of the fluid light guide 30 up to the acceptance angle of 72° full angle and beyond is ensured by the optical coupling module 20. The distance a* between the high-power single-cell LED 12 and the entrance window 31 of the liquid light guide 30 is 117 mm in this case. For the components with the diameters and distances already mentioned above, the quality of the image of this optical coupling module 20 is fully sufficient for light coupling from an LED into a fluid light guide.

Very good imaging performance is achieved for illumination purposes, particularly in the medium range of the above-mentioned magnification.

FIG. 10 shows the optical diagram with the 380 fluid light guide 30 from Lumatec, which is shown here as a fluid light guide with an optical diameter of 5 mm. The light emerging from the exit window 32 of the fluid light guide 30 strikes the high-aperture, asymmetrical condenser lens 41. This high-aperture, asymmetrical condenser lens 41 is aspherical on one side of the lens and has a focal length of f41′=7.5 mm and a diameter of 12 mm, and its more strongly curved, aspherical surface faces the iris diaphragm 43. This converging lens 41 is sold by Edmund Optics under item number 35-039. The iris diaphragm 43 is set to a diameter of 6 mm in FIG. 10. The fluid light guide 30 is positioned in the front focal plane with the focal point F41 of the high-aperture, asymmetrical condenser lens 41. This also results in a very homogeneous light distribution in the rear focal plane with the focal point F41′ due to the very uniform light emission of the fluid light guide 30 in the angular range. The iris diaphragm 43 here represents the object to be imaged in focus, which is imaged by the thin additional lens 80 and also by the first 51 and the second 52 light-collecting, cemented, achromatic lens doublet, which are identical in construction. The thin additional lens 80 is designed here as a collecting spectacle lens in meniscus form with a refractive power of +1.5 diopters and serves to increase the refractive power during imaging and to achieve a free working distance aL of 100 mm. The lens is made of the thermosetting plastic polyallyl diglycol carbonate (CR-39) for spectacle lenses, which has an Abbe number of 58 and thus a comparatively low dispersion in order to minimize chromatic aberrations when imaging the iris diaphragm 43. The diameter of the collecting lens is 40 mm. The light-collecting, cemented, achromatic lens doublets 51 and 52 have focal lengths f51′ equal to f52′ equal to 120 mm and also each have a diameter of 40 mm. The lens bellies of the two light-collecting, cemented, achromatic lens doublets 51 and 52 are turned towards each other. These light-collecting, cemented, achromatic lens doublets 51 and 52 are sold by the company Qioptic with the article number G322388000. The homogeneous light field 60 is created by imaging the illuminated iris diaphragm 43. This light field 60 with the associated imaging beam path is shown here clearly too large in height for the sake of clarity. The light spot P lies in the plane of the iris diaphragm 43 and coincides with the rear focal point F42′ of the high-aperture optical lens 42. The image point P′ in the light field 60 is optically conjugated to the light point P by imaging using the thin additional lens 80 and the two light-collecting, cemented, achromatic lens doublets 51 and 52. The change of scale in the illustration with the enlargement of the same by a factor of approximately 3.3 on the left-hand side of FIG. 10 makes sense here, because otherwise the details cannot be displayed well on the left-hand side. In the arrangement shown in FIG. 10, the free distance aL=100 mm. At least approximately, this arrangement according to FIG. 10 with the specified dimensions and components results in the magnification beta′ to one. Full illumination of the iris diaphragm 43 is achieved up to a diameter of approximately 8 mm.

In a fifth embodiment example without figure, a fluid light guide 30 with a diameter of 8 mm is used in an arrangement according to FIG. 10. If this is operated with a high-aperture, asymmetrical condenser lens 41 with a diameter of 20 mm and a focal length of 11 mm, the iris diaphragm 43 is fully illuminated up to a diameter of approximately 12 mm. The aspherical condenser lens 35-052 from Edmund Optics can be used for this purpose.

FIG. 11 shows the design view with the fluid light guide 30 and its exit window 32 as well as the diaphragm tube 40, an intermediate tube 49 and the imaging stage 50. The high-aperture, asymmetrical condenser lens 41 and the iris diaphragm 43 are arranged in the diaphragm tube. The imaging stage 50 contains the thin additional lens 80 in meniscus form with a positive refractive power of 1.5 diopters made of the thermoset material CR39 as well as the two identical, light-collecting, cemented, achromatic lenslets 51 and 52 with a focal length of 120 mm and a diameter of 40 mm from the company Qioptic with the article number G322388000. It is essential for the avoidance of one or even several very undesirable halos in the vicinity of the light field 60 that the free inner diameter DL of the intermediate tube 49 is larger than the diameter of both the thin additional lens 80 and the light-collecting, cemented, achromatic lens doublets 51 and 52. Thus, the inner diameter of the intermediate tube 49 is 42 mm.

### LIST OF REFERENCE SYMBOLS

10 Continuous light source with a high-power single-cell LED 12
11 Power supply for the high-power single-cell LED 12
12 High-power single-cell LED with an electrical power consumption greater than or equal to 20 W and a color rendering index (CRI) greater than or equal to 95
20 optical coupling module
21 aspherical lens in the optical coupling module 20.
   This is the first aspherical lens in the optical coupling module 20.
22 Aspherical lens in the optical coupling module 20
   This is the second aspherical lens in the optical coupling module 20.
30 Fluid light guide. A fluid light guide is also referred to as a liquid light guide.
31 Inlet window of the fluid light guide 30
32 Exit window of the fluid light guide 30
40 Diaphragm tube
41 High-aperture, asymmetrical condenser lens
42 Shading screen
43 Iris diaphragm
49 Intermediate tube
50 Imaging level
51 First light-collecting, cemented, achromatic lens doublet
52 Second light-collecting, cemented, achromatic lens doublet
53 Front mechanical stop of the mount for imaging stage 50
60 circular light field. The diameter of the light field is calculated using the half-value diameter HWD in relation to the maximum illuminance Emax.
70 Photo lens with the SE focal plane for macro photography of an object or object detail
71 Front lens of the photographic lens 70
80 Thin additional lens in imaging level 50
81 Lens belly of the thin additional lens (80) in meniscus form
91 Light-collecting, cemented, achromatic lens doublet arranged individually in imaging stage 50
92 Steinheil triplet achromat
93 Second Steinheil triplet achromat
94 First Hastings triplet achromat
95 Second Hastings triplet achromat
A Area with possible space problems
a free working distance between the front stop of the mount of the imaging stage 50, which does not contain a converging lens, and the light field 60
aL free working distance between the front stop of the mount of the imaging stage 50, which contains the converging lens 80, and the light field 60
a* Distance between the high-power single-cell LED 12 and the entrance window 31 of the liquid light guide 30
af Out-of-focus deposition with the first light-collecting, cemented, achromatic lens doublet 51
BE Aperture plane
beta′ Image scale of an image step
beta_pK′ paraxial magnification of the optical coupling module 20
BFL Back focal length. This is also known as the rear focal length and is calculated from the apex of the lens to the focal point.
CRI Color Rendering Index
   The term color rendering index is also used for this.
DL clear diameter of the tube of imaging stage 50
E Illuminance
Emax Maximum illuminance in the center of a circular light field 60
F21 paraxial front focal point of aspherical lens 21
F22′ Paraxial rear focal point of aspherical lens 22
F41 paraxial front focal point of the high-aperture, asymmetrical condenser lens 41
F41′ Paraxial rear focal point of the high-aperture, asymmetrical condenser lens 41
f41 Paraxial focal length of the high-aperture, asymmetrical condenser lens 41
F51 Front focal point of the first light-collecting, cemented, achromatic lens doublet 51
f51 Focal length of the first light-collecting, cemented, achromatic lens doublet 51
F52′ Rear focal point of the second light-collecting, cemented, achromatic lens doublet 52
f52 Focal length of the second light-collecting, cemented, achromatic lens doublet 52
F91 Front focal point of a single light-collecting, cemented, achromatic lens doublet 91
F91′ Rear focal point of a single light-collecting, cemented, achromatic lens doublet 91
f91′ Focal length of a single light-collecting, cemented, achromatic lens doublet 91
F92 front focal point of the Steinheil triplet achromat 92
F92′ rear focal point of the Steinheil triplet achromat 92
f92′ Focal length of the Steinheil triplet achromat 92
F93 Front focal point of the Steinheil triplet achromat 93
F93′ rear focal point of the Steinheil triplet achromat 93
f93′ Focal length of the Steinheil triplet achromat 93
F94 Front focal point of the Hastings triplet achromat 94
F94 rear focal point of the Hastings triplet achromat 94
f94′ Focal length of the Hastings triplet achromat 94
F95 front focal point of the Hastings triplet achromat 95
F95′ rear focal point of the Hastings triplet achromat 95
f95′ Focal length of the Hastings triplet achromat 95
HWD Half-value diameter of the light field 60 in the plane of the best edge sharpness, in relation to the maximum illuminance Emax in the center of the light field
   It is HWD=D(0.5Emax).
K Line contrast of line pairs at the edge of the light field 60
LSE Plane with best edge sharpness of the light field
P Point of light
P′ Image point, optical conjugation of the light point P
r Radius of the light field 60
SE Plane of focus of the photographic lens 70
s1 Object-side section width of the first aspherical lens 21
s2′ image-side section width of the second aspherical lens 22
S52′ Image-side apex of the light-collecting, cemented, achromatic lens doublet 52

1.-35. (canceled)

36. An arrangement for generating a spaced, adjustable light field for macro photography, in particular also for object-adapted illumination with a sharp light field edge and with a light field having at least one lateral dimension of greater than or equal to 0.9 mm and a maximum lateral dimension of less than or equal to 12 mm for illuminating small objects and small object details, comprising:
an LED,
a light guide,
a shading aperture, and
an imaging stage,
wherein the arrangement for generating a spaced, adjustable light field for macro photography comprises the following components:
an LED configured as a continuous light LED with at least 20 W electrical power consumption and a Color Rendering Index (CRI) of greater than or equal to 90,
an optical coupling module,
a light guide configured as a fluid light guide with a diameter of the optically usable area between 2.5 mm and 10 mm, which is downstream of the optical coupling module,
a diaphragm tube comprising a high-aperture, asymmetrical condenser lens and at least one shading aperture downstream of the high-aperture, asymmetrical condenser lens, whose image forms the light field,
an imaging stage downstream of the diaphragm tube with a magnification value beta′ for imaging the shading aperture between 0.7 and 2,
the optical coupling module being equipped with two positive and asymmetrically designed aspherical lenses with a numerical aperture of at least 0.4,
the paraxial magnification beta_pK′ of the optical coupling module being between 0.5 and 1.2,
the fluid light guide having a length of at least 0.8 m and being arranged between the optical coupling module and the diaphragm tube,
the exit window of the fluid light guide being arranged at least approximately in the front focal plane of the asymmetrical condenser lens,
the high-aperture, asymmetrical condenser lens in the diaphragm tube having a focal length of at least 4 mm and at most 24 mm, with a numerical aperture always at least 0.4, and the more curved lens surface of the high-aperture, asymmetrical condenser lens facing the shading aperture,
the imaging stage comprising at least one light-collecting, achromatic lens group with a lens diameter of at least 38 mm, for generating a sharply bordered light field as a result of the image of the shading aperture, and
the free working distance to the light field from the front mechanical stop of the imaging stage being at least 80 mm.

37. The arrangement for generating a spaced, adjustable light field for macro photography according to claim 36, wherein the imaging stage comprises two light-collecting, cemented achromatic lens doublets instead of a single light-collecting achromatic lens group, each designed with an optical design on one side for a beam path to infinity, with a focal length of at least 80 mm and at most 200 mm.

38. The arrangement for generating a spaced, adjustable light field for macro photography according to claim 37, wherein the two light-collecting, cemented achromatic lens doublets in the imaging stage have different focal lengths, each at least 80 mm, and the ratio of their focal lengths is between 0.7 and 2.

39. The arrangement for generating a spaced, adjustable light field for macro photography according to claim 37, wherein the two light-collecting, cemented achromatic lens doublets in the imaging stage each have a focal length of 120 mm.

40. The arrangement for generating a spaced, adjustable light field for macro photography according to claim 38, wherein one of the two light-collecting, cemented achromatic lens doublets in the imaging stage have a focal length of 100 mm and the other has a focal length of 120 mm.

41. The arrangement for generating a spaced, adjustable light field for macro photography according to claim 40, wherein the first of the two light-collecting, cemented achromatic lens doublets in the imaging stage have a focal length of f51′=100 mm, and the second lens doublet in the imaging stage has a focal length of f52′=120 mm.

42. The arrangement for generating a spaced, adjustable light field for macro photography according to claim 41, wherein the shading aperture is arranged with an extra-focal offset af relative to the focal point F51F51F51 of the first light-collecting, cemented achromatic lens doublet in the imaging stage, with an offset af of up to 15 mm.

43. The arrangement for generating a spaced, adjustable light field for macro photography according to claim 38, wherein a thin additional lens is assigned to the two light-collecting, cemented achromatic lens doublets in the imaging stage, the refractive power of the additional lens being between 0.5 diopters and 2.0 diopters.

44. The arrangement for generating a spaced, adjustable light field for macro photography according to claim 43, wherein the material of the thin additional lens has an Abbe number of at least 56.

45. The arrangement for generating a spaced, adjustable light field for macro photography according to claim 44, wherein the thin additional lens is designed as a converging lens.

46. The arrangement for generating a spaced, adjustable light field for macro photography according to claim 44, wherein the thin additional lens is designed as a diverging lens.

47. The arrangement for generating a spaced, adjustable light field for macro photography according to claim 45, wherein the thin additional lens is designed in the form of a meniscus, with the convex side of the lens respectively facing a light-collecting, cemented achromatic lens doublets in the imaging stage.

48. The arrangement for generating a spaced, adjustable light field for macro photography according to claim 43, wherein the thin additional lens is made of the thermosetting plastic Polyallyldiglycolcarbonate for eyeglass lenses.

49. The arrangement for generating a spaced, adjustable light field for macro photography according to claim 43, wherein the thin additional lens is made of mineral glass with an Abbe number of at least 56.

50. The arrangement for generating a spaced, adjustable light field for macro photography according to claim 47, wherein the thin additional lens in meniscus form is arranged in the imaging stage in the beam path upstream of the first light-collecting, cemented achromatic lens doublet, with its convex side facing the light-collecting, cemented achromatic lens doublet.

51. The arrangement for generating a spaced, adjustable light field for macro photography according to claim 39, wherein a thin additional lens is assigned to the two light-collecting, cemented achromatic lens doublets in the imaging stage, the refractive power of the additional lens being between 0.5 diopters and 2.0 diopters;
wherein the thin additional lens in meniscus form is designed with a refractive power of +1.5 diopters.

52. The arrangement for generating a spaced, adjustable light field for macro photography according to claim 50, wherein the magnification of the imaging stage, with the two light-collecting, cemented achromatic lens doublets and the thin additional lens in meniscus form with a refractive power of +1.5 diopters, is at least approximately one.

53. The arrangement for generating a spaced, adjustable light field for macro photography according to claim 36, wherein the high-aperture, asymmetrical condenser lens has a numerical aperture of 0.8 and a positive focal length of 7.5 mm.

54. The arrangement for generating a spaced, adjustable light field for macro photography according to claim 36, wherein the high-aperture, asymmetrical condenser lens has a numerical aperture of 0.8 and a positive focal length of 20 mm.

55. The arrangement for generating a spaced, adjustable light field for macro photography according to claim 36, wherein at least one LED with a Color Rendering Index (CRI) value of at least 95 is used as the light source in the arrangement for generating a spaced, adjustable light field for macro photography.
